(19) United States
(12) Patent Application Publication
(10) Pub. No.: US 2026/0072263 A1
(43) Pub. Date: Mar. 12, 2026

(54) MICROSCOPE OBJECTIVE LENS SWITCHING DEVICE

(71) Applicant: AAC Microtech (Changzhou) Co., Ltd., Changzhou City (CN)

(72) Inventors: Chongdeng Wu, Changzhou (CN); Rui Zhang, Changzhou (CN); Zhou Yu, Changzhou (CN); Huifang Dong, Changzhou (CN); Jialin Wang, Changzhou (CN)

(21) Appl. No.: 19/006,245

(22) Filed: Dec. 31, 2024

Related U.S. Application Data
(63) Continuation of application No. PCT/CN2024/118256, filed on Sep. 11, 2024.

(51) Int. Cl. G02B 21/02; G02B 7/02; G02B 7/16; G02B 26/08

(52) U.S. Cl. CPC G02B 21/025; G02B 7/021; G02B 7/16; G02B 26/0875

(57) ABSTRACT

A microscope objective lens switching device is provided for switching objective lenses of a microscope. The microscope objective lens switching device is used to switch the objective lenses of the microscope. In the microscope objective lens switching device of the present disclosure, by using the balls to support rotation in the outer ring of the switching device and using the roller bearing assembly to support rotation in the inner ring of the switching device, the accuracy and rigidity of the roller bearing assembly are higher, the accuracy of the microscope objective lens switching device is also higher, the processing requirements for processing members of the microscope objective lens switching device are lower, and the cost is lower.

### CROSS REFERENCE TO RELATED APPLICATIONS

The present application is a continuation of PCT Patent Application No. PCT/CN2024/118256, filed Sep. 11, 2024, which is incorporated by reference herein in its entirety.

### TECHNICAL FIELD

The various embodiments described in this document relate in general to the technical field of microscopes, and more specifically to a microscope objective lens switching device.

### BACKGROUND

The microscope has a very significant magnification function, which typically includes multiple eyepieces and multiple objective lenses, and different combinations are configured according to different needs to achieve different magnifications. Since the magnification is relatively large, a small deviation may cause a huge shift in imaging. In this case, a high-precision objective lens switching device is needed. In the related technologies, there is a structure in which a layer of balls is adopted between a supporting disc surface and a base of the objective lens switching device to support rotation of the disc surface relative to the base, but this structure has a great influence on the position accuracy of a base of a nosepiece (turntable base) of objective lenses of the microscope, so the material and processing requirements of the base of the nosepiece and the disc surface are very high, the cost is also relatively high, and the performance of the finished objective lens switching device of the microscope is also poor.

Therefore, it is necessary to provide a new microscope objective lens switching device to solve the above technical problems.

### SUMMARY

Embodiments of the present disclosure aim to provide a microscope objective lens switching device to meet the requirements of high precision and cost reduction.

In view of the above, the present disclosure provides a microscope objective lens switching device configured to switch objective lenses of a microscope. The microscope objective lens switching device includes a turntable base, a disc surface rotatably connected with the turntable base, a driving assembly configured to provide a driving force, and a transmission assembly configured to transmit the driving force to the disc surface to enable the disc surface to rotate relative to the turntable base. The transmission assembly includes a worm connected to the driving assembly, a worm gear engaged and cooperated with the worm, a roller bearing assembly connecting the worm gear and the turntable base. The microscope objective lens switching device further includes a set of balls engaged at a circumference of the disc surface and a circumference of the turntable base. The roller bearing assembly includes an outer bearing connected to the turntable base, an inner bearing connected to the worm gear, and a plurality of rollers provided between the outer bearing and the inner bearing.

In some embodiments, each of the plurality of rollers has a cylindrical shape.

In some embodiments, the plurality of rollers includes first rollers arranged in a circle and second rollers. Each respective second roller of the second rollers is provided between a corresponding pair of adjacent first rollers. A respective first roller of the first rollers has an axis extending in a tangential direction of the circle, and the respective second roller of the second rollers has an axis extending in a direction perpendicular to the extending direction of an axis of a corresponding first roller of the first rollers.

In some embodiments, an included angle between the axis of the respective second roller and a plane on which the circle is located is greater than 0° and less than 90°.

In some embodiments, the outer bearing has an annular structure, the outer bearing includes a first annular surface facing the inner bearing, and the first annular surface defines a first accommodating groove. The inner bearing has an annular structure, the inner bearing includes a second annular surface facing the outer bearing, and the second annular surface defines a second accommodating groove. The first accommodating groove and the second accommodating groove cooperatively form an accommodating groove for accommodating the plurality of rollers, and the accommodating groove has a cross section of a square.

In some embodiments, the transmission assembly further includes a transition stud connecting the worm gear and the disc surface, and the transition stud is configured to transmit the driving force to the disc surface to drive the disc surface to rotate.

In some embodiments, the transmission assembly further includes a bearing post disposed within the worm gear and partially extending into the roller bearing assembly.

In some embodiments, the microscope objective lens switching device further includes a cover covering the transition stud, and the cover has a surface substantially flush with a surface of the disc surface.

In some embodiments, the turntable base includes a first accommodating portion for accommodating a portion of the transmission assembly at a middle position of the turntable base, and a second accommodating portion for accommodating the driving assembly and another portion of the transmission assembly on a side of the first accommodating portion.

In some embodiments, the turntable base defines a light passing hole on a side of the turntable base opposite to the second accommodating portion.

Compared with the related technologies, embodiments of the present disclosure provide a microscope objective lens switching device. The microscope objective lens switching device is used to switch the objective lenses of the microscope. The microscope objective lens switching device includes the turntable base, the disc surface rotatably connected with the turntable base, a driving assembly providing a driving force, and the transmission assembly configured to transmit the driving force to the disc surface so that the disc surface rotates relative to the turntable base. The transmission assembly includes the worm connected to the driving assembly, the worm gear engaged and mated with the worm, and the roller bearing assembly connecting the worm gear and the turntable base. The microscope objective lens switching device further includes the set of balls engaged at the circumference of the disc surface and the circumference of the turntable base. The roller bearing assembly includes the outer bearing connected to the turntable base, the inner bearing connected to the worm gear, and the plurality of rollers provided between the outer bearing and the inner bearing. In the microscope objective lens switching device of the present disclosure, by using the balls to support rotation of the disc surface relative to the turntable base in the outer ring of the switching device and using the roller bearing assembly to support rotation of the disc surface relative to the turntable base in the inner ring of the switching device, the accuracy and rigidity of the roller bearing assembly are higher, the accuracy of the microscope objective lens switching device is also higher, and the processing requirements for processing members of the microscope objective lens switching device are lower.

### BRIEF DESCRIPTION OF THE DRAWINGS

FIG. 1 is a three-dimensional schematic structural diagram of a microscope objective lens switching device according to an embodiment of the disclosure.

FIG. 2 is a partially exploded view of the microscope objective lens switching device shown in FIG. 1.

FIG. 3 is another partial exploded view of the microscope objective lens switching device shown in FIG. 1.

FIG. 4 is an exploded view of some components of the microscope objective lens switching device shown in FIG. 1.

FIG. 5 is a cross-sectional view taken along line A-A in FIG. 1.

### DETAILED DESCRIPTION OF THE EMBODIMENTS

The technical solutions in the embodiments of the present disclosure will be clearly and completely described below in combination with the drawings in the embodiments of the present disclosure. Obviously, the described embodiments are merely some embodiments of the present disclosure, rather than all embodiments. Based on the embodiments in the present disclosure, all other embodiments obtained by ordinary skilled personnel in the art without making creative effort belong to the scope of protection of the present disclosure.

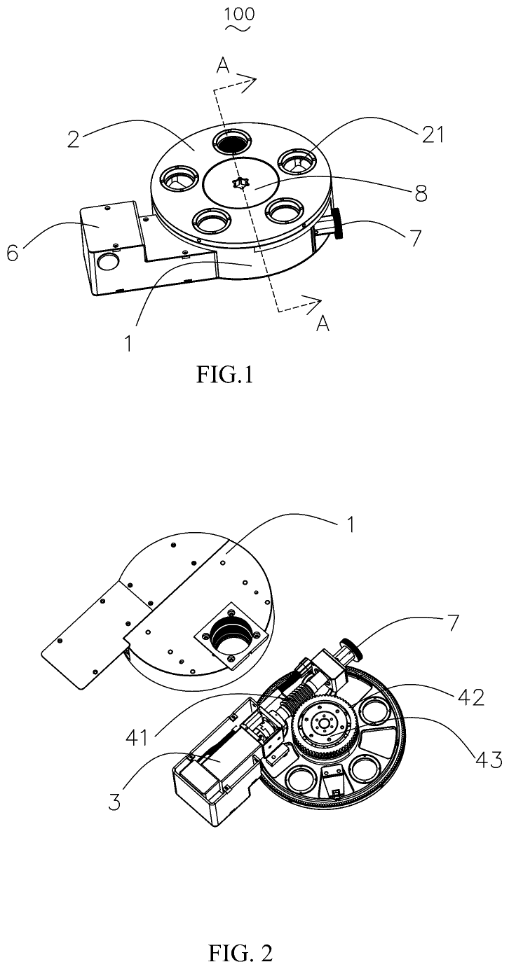

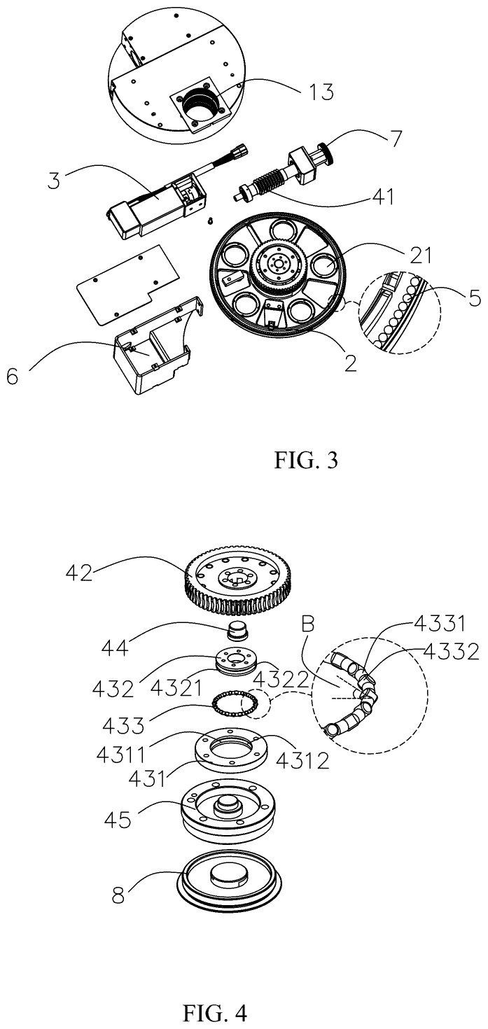

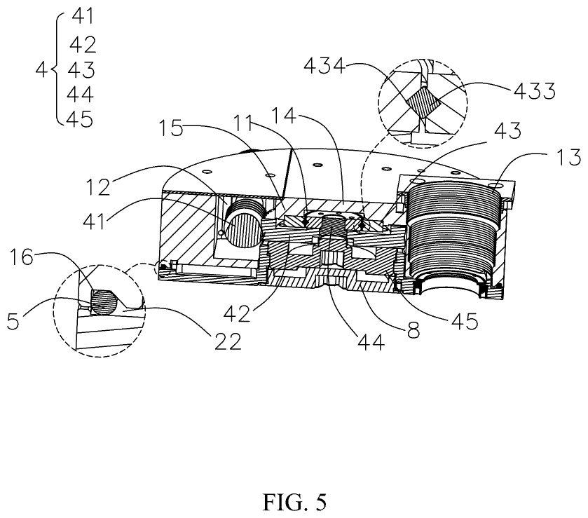

As shown in FIGS. 1 to 5, embodiments of the present disclosure provide a microscope objective lens switching device 100 for switching objective lenses of a microscope. The microscope objective lens switching device 100 includes a turntable base 1, a disc surface 2 rotatably connected with the turntable base 1, a driving assembly 3 configured to provide a driving force, a transmission assembly 4 configured to transmit the driving force to the disc surface 2 so that the disc surface 2 rotates relative to the turntable base 1, a set of balls 5 arranged between the turntable base 1 and the disc surface 2, a housing 6 cooperating with the turntable base 1 for receiving the driving assembly 3 and transmission assembly 4, a manual knob 7 extending out of the turntable base 1, and a cover 8.

The turntable base 1 is configured to be connected with an eyepiece system of the microscope. The driving assembly 3 is fixed on the turntable base 1. The turntable base 1 includes a first accommodating portion 11 for accommodating a portion of the transmission assembly 4 at a middle position of the turntable base 1, a second accommodating portion 12 for accommodating the driving assembly 3 and another portion of the transmission assembly 4 on a side of the first accommodating portion 11, and defines a light passing hole 13 on a side of the turntable base 1 opposite to the second accommodating portion 12. The turntable base 1 includes a top wall 14 and an extension wall 15 extending from the top wall 14 toward the disc surface 2, and the turntable base 1 defines at least one first groove 16 along a circumference of the turntable base 1.

The disc surface 2 has an annular flat plate structure, and the disc surface 2 defines a plurality of connection holes 21 for connecting objective lenses. In this embodiment, there may be five connection holes 21, and other numbers of connection holes 21 may be set according to actual needs, such as three connection holes 21, four connection holes 21, or the like. The disc surface 2 defines at least one second groove 22 along a circumference of the disc surface 2. The at least one first groove 16 of the turntable base 1 and the at least one second groove 22 of the disc surface 2 cooperatively form a groove for accommodating the set of balls 5.

In this embodiment, the driving assembly 3 is a stepping motor. During operating, the driving assembly 3 drives the disc surface 2 to rotate relative to the turntable base 1 through the transmission assembly 4, and the disc surface 2 drives the objective lens es to rotate, to achieve switching of the objective lenses.

The transmission assembly 4 includes a worm 41 connected to the driving assembly 3, a worm gear 42 engaged and mated/cooperated with the worm 41, a roller bearing assembly 43 connecting the worm gear 42 and the turntable base 1, a bearing post 44 provided in the worm gear 42, and a transition stud 45 connecting the worm gear 42 and the disc surface 2. The transition stud 45 is configured to transmit the driving force to the disc surface 2 to drive the disc surface 2 to rotate.

The worm 41 is provided with threads, and the worm gear 42 is provided with meshing teeth. The threads are meshed with the meshing teeth. The driving assembly 3 rotates to drive the worm 41 to rotate, the worm 41 drives the worm gear 42 to rotate, and finally the disc surface 2 is driven to rotate through the transition stud 45.

The roller bearing assembly 43 includes an outer bearing 431 connected to the turntable base 1, an inner bearing 432 connected to the worm gear 42, and a plurality of rollers 433 provided between the outer bearing 431 and the inner bearing 432. Each of the rollers 433 has a cylindrical shape. The outer bearing 431 is fixedly connected to the extension wall 15 of the turntable base 1, and the inner bearing 432 is fixedly connected to the worm gear 42 and the bearing post 44.

The plurality of rollers 433 include first rollers 4331 arranged in a circle and second rollers 4332, where each of the second rollers 4332 is provided between a corresponding pair of adjacent first rollers 4331. Each of the first rollers 4331 has an axis extending in a tangential direction of the circle, and each of the second rollers 4332 has an axis extending in a direction perpendicular to the extending direction of the axis of the corresponding first roller 4331 of the first rollers 4331. An included angle B between the axis of the second roller 4332 and a plane on which the circle is located is greater than 0° and less than 90°. The outer bearing 431 has an annular structure. The outer bearing 431 includes a first annular surface 4311 facing the inner bearing 432. The first annular surface 4311 defines a first accommodating groove 4312. The inner bearing 432 has an annular structure. The inner bearing 432 includes a second annular surface 4321 facing the outer bearing 431, and the second annular surface 4321 defines a second accommodating groove 4322. The first accommodating groove 4312 and the second accommodating groove 4322 cooperatively form an accommodating groove 434 for accommodating the plurality of rollers 433. The accommodating groove 434 has a cross section of a square.

The first rollers 4331 and the second rollers 4332 form a crossing roller structure, so that the accuracy and rigidity of the roller bearing assembly 43 are relatively high, and the accuracy of the microscope objective lens switching device 100 is relatively high, the processing requirements for the processing members of the microscope objective lens switching device 100 are relatively low, and the cost is also reduced.

The bearing post 44 extends partially from an interior of the worm gear 42 into the roller bearing assembly 43, so that the worm gear 42 and the roller bearing assembly 43 can be accurately positioned and connected, and the bearing post 44 rotates together with the worm gear 42 and the inner bearing 432.

The set of balls 5 is engaged at the circumference/periphery of the disc surface 2 and the circumference/periphery of the turntable base 1, so that the disc surface 2 and the turntable base 1 form support in a vertical direction. The set of balls 5 are arranged in a circle, and adjacent balls 5 abut each other.

The housing 6 is made of a metal material, and the housing 6 cooperates with the turntable base 1 to accommodate other components.

The manual knob 7 is screwed with an end of the worm 41 away from the driving assembly 3. By providing the manual knob 7, the flexibility of the microscope objective lens switching device can be further improved.

The cover 8 covers the transition stud 45. A surface of the cover 8 is substantially flush with a surface of the disc surface 2, and the cover 8 rotates with the disc surface 2.

Compared with the related technologies, embodiments of the present disclosure provide a microscope objective lens switching device. The microscope objective lens switching device is used to switch the objective lenses of the microscope. The microscope objective lens switching device includes the turntable base, the disc surface rotatably connected with the turntable base, a driving assembly providing a driving force, and the transmission assembly configured to transmit the driving force to the disc surface so that the disc surface rotates relative to the turntable base. The transmission assembly includes the worm connected to the driving assembly, the worm gear engaged and mated with the worm, and the roller bearing assembly connecting the worm gear and the turntable base. The microscope objective lens switching device further includes the set of balls engaged at the circumference of the disc surface and the circumference of the turntable base. The roller bearing assembly includes the outer bearing connected to the turntable base, the inner bearing connected to the worm gear, and the plurality of rollers provided between the outer bearing and the inner bearing. In the microscope objective lens switching device of the present disclosure, by using the balls to support rotation of the disc surface relative to the turntable base in the outer ring of the switching device and using the roller bearing assembly to support rotation of the disc surface relative to the turntable base in the inner ring of the switching device, the accuracy and rigidity of the roller bearing assembly are higher, the accuracy of the microscope objective lens switching device is also higher, and the processing requirements for processing members of the microscope objective lens switching device are lower.

The above is merely the embodiments of the present disclosure. Here, it shall be pointed out that for the ordinary skilled personnel in the art, improvements can be made without departing from the concept of creation of the present disclosure, but these belong to the scope of protection of the present disclosure.

What is claimed is:

1. A microscope objective lens switching device, configured to switch objective lenses of a microscope, and comprising:
a turntable base, a disc surface rotatably connected with the turntable base, a driving assembly configured to provide a driving force, and a transmission assembly configured to transmit the driving force to the disc surface to enable the disc surface to rotate relative to the turntable base;
wherein the transmission assembly includes a worm connected to the driving assembly, a worm gear engaged and cooperated with the worm, a roller bearing assembly connecting the worm gear and the turntable base; and
wherein the microscope objective lens switching device further includes a set of balls engaged at a circumference of the disc surface and a circumference of the turntable base, and wherein the roller bearing assembly includes an outer bearing connected to the turntable base, an inner bearing connected to the worm gear, and a plurality of rollers provided between the outer bearing and the inner bearing.

2. The microscope objective lens switching device of claim 1, wherein each of the plurality of rollers has a cylindrical shape.

3. The microscope objective lens switching device of claim 2, wherein the plurality of rollers includes first rollers arranged in a circle and second rollers, wherein each respective second roller of the second rollers is provided between a corresponding pair of adjacent first rollers;
wherein a respective first roller of the first rollers has an axis extending in a tangential direction of the circle, and the respective second roller of the second rollers has an axis extending in a direction perpendicular to the extending direction of the axis of a corresponding first roller of the first rollers.

4. The microscope objective lens switching device of claim 3, wherein an included angle between the axis of the respective second roller and a plane on which the circle is located is greater than 0° and less than 90°.

5. The microscope objective lens switching device of claim 4, wherein the outer bearing has an annular structure, the outer bearing includes a first annular surface facing the inner bearing, and the first annular surface defines a first accommodating groove;
wherein the inner bearing has an annular structure, the inner bearing includes a second annular surface facing the outer bearing, and the second annular surface defines a second accommodating groove; and
wherein the first accommodating groove and the second accommodating groove cooperatively form an accommodating groove for accommodating the plurality of rollers, and the accommodating groove has a cross section of a square.

6. The microscope objective lens switching device of claim 1, wherein the transmission assembly further comprises a transition stud connecting the worm gear and the disc surface, and the transition stud is configured to transmit the driving force to the disc surface to drive the disc surface to rotate.

7. The microscope objective lens switching device of claim 6, wherein the transmission assembly further comprises a bearing post disposed within the worm gear and partially extending into the roller bearing assembly.

8. The microscope objective lens switching device of claim 6, wherein the microscope objective lens switching device further comprises a cover covering the transition stud, and the cover has a surface substantially flush with a surface of the disc surface.

9. The microscope objective lens switching device of claim 1, wherein the turntable base includes a first accommodating portion for accommodating a portion of the transmission assembly at a middle position of the turntable base, and a second accommodating portion for accommodating the driving assembly and another portion of the transmission assembly on a side of the first accommodating portion.

10. The microscope objective lens switching device of claim 9, wherein the turntable base defines a light passing hole on a side of the turntable base opposite to the second accommodating portion.
